(19) United States
(12) Patent Application Publication
(10) Pub. No.: US 2006/0080354 A1
(43) Pub. Date: Apr. 13, 2006

(54) System for selecting data from a data store based on utility of the data

(75) Inventors: Adam Berger, Pittsburgh, PA (US); Richard Romero, Pittsburgh, PA (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/928,615

(22) Filed: Aug. 27, 2004

(51) Int. Cl. G06F 17/00

(52) U.S. Cl. 707/103 R

(57) ABSTRACT

A method and corresponding equipment for selecting data objects from a set of data objects in a source data store according to a predetermined method for assigning utility for each of the data objects in the set of data objects. The predetermined method for assigning utility typically takes into account a plurality of factors, and provides weights for each, so that, for example, the utility assigned to a data object decreases in time, but is enhanced if the data object has not yet been viewed by a user or if the data object is marked to indicate that a follow-up action is required. The invention is of use for example as part of or in connection with a mobile phone messaging user agent that stores in the mobile phone only the higher utility data objects (messages) in a full set of data objects.

### TECHNICAL FIELD

The present invention pertains to storing data in a data store, and more particularly, for selecting from a set of data only a subset of the data to store in a data store, as for example in at least partially synchronizing a target data store to a source data store, or in selecting email or email attachments to keep in a mailbox.

### BACKGROUND ART

In synchronizing a smaller data store to a larger data store, in general not all data in the larger data store can be transferred to the smaller data store. Thus, the synchronization must involve choosing only a subset of the data in the larger data store.

The problem of choosing a subset of data (sometimes called data objects or simply objects, and so including any possible organization of information, such as data in a data record or file of a data store, or the record or file itself) from a larger collection of data arises frequently in mobile information access in many different tasks. Such tasks can in general be characterized as server-mobile synchronization, referring to transferring data to a mobile device, such as a mobile phone or a USB keychain, or personal digital assistant, and so on. Mobile phones typically include various personal information management (PIM) software applications such as a calendar, a phone book, a to-do list software application, and a mailbox. Users may enter information manually into these mobile software applications, but many people rely primarily on a personal computer (PC) or a remote group-ware server as the primary store of such information. More and more, people are using the email/PIM software applications on their mobile phones as a “mirror” or cache of a primary, server-based repository.

To copy information to a mobile device, a user can invoke a synchronization program, causing a transfer of data between the mobile device and a remote computer according to one or another synchronization protocol. A common synchronization protocol is SyncML Protocol v1.1.1, whose specification is available at www.syncml.org. Depending on the amount of data stored on the server since the last synchronization, the synchronization may involve a significant amount of data transfer. For example, it is not unusual for a mailbox to exceed tens or even hundreds of megabytes (MB) even if only a relatively small number of emails are in the mailbox because each can include attachments, and some can be large (graphic images in particular).

Over a radio interface, network performance and operator-imposed fees may prevent synchronizing an entire data store to a mobile device. Even over a free and/or high-speed connection, a mobile device may lack the capacity to store an entire data store. In such cases, only some objects in the data store can be transferred to the mobile device, objects in a selected subset. The prior art provides simple methods of selecting objects to transfer—methods using a rule such as “store the most recently-created objects.” Often, such a simple approach is less than ideal, e.g. in the case of old objects that are important, new ones that are not important, or a large new object that crowds out everything else. Another approach provided by the prior art is to require a user to manually select the objects to synchronize, but clearly such an approach can be burdensome. (In case of mobile messaging user agent message stores, the prior art also teaches storing on a mobile device only a sliding window of the most recent messages, and automatically removing messages that fall outside the window. This can be viewed as a form of selecting objects using the “store the most recently-created objects” rule.)

The problem of choosing only a subset of data from a set of data also arises in case of an ISP (Internet Service Provider) or other enterprise hosting email for a client. Most ISPs and enterprises impose a quota on the size of a user's mailbox. Such a quota is sometimes as small as 5 MB. Any fixed quota, even a large one, forces users to spend time eliminating messages from the mailbox or moving them to another storage repository. As before, such a task can be done manually or using the simple solutions provided by the prior art.

Thus, what is needed is a more sophisticated automated procedure for selecting only some data in a set of data, a procedure more likely to be truly useful than the simple automated solutions provided by the prior art.

### DISCLOSURE OF THE INVENTION

Accordingly, in a first aspect of the invention, a method is provided, comprising: a step of selecting a subset of data objects from a set of data objects in a source data store; and a step of saving the selected data objects in a target data store; wherein the step of selecting the subset of data objects is performed according to a predetermined method for assigning utility for each of the data objects in the set of data objects.

In accord with the first aspect of the invention, the step of selecting the subset of data objects may be performed so as to include in the subset at least some data objects in the source data store having high utility according to the predetermined method for assigning utility.

Also in accord with the first aspect of the invention, the predetermined method for assigning utility may be based on a model that takes into account a plurality of factors, and provides weights for each of the factors. Further, the weights may be based on monitoring access of the data objects by at least one user. Also further, the weights may be based on monitoring access of the data objects by a set of users, and then adapted to a particular user based on monitoring the particular user.

Also in accord with the first aspect of the invention, the factors may be such that the utility assigned to a data object decreases continually over time, but is enhanced if the data object has not yet been viewed or if the data object is marked to indicate a follow-up action is required.

Also in accord with the first aspect of the invention, the source data store may be hosted by a mobile device and the target data store may be a temporary data store existing only during a compacting of the source data store, and the mobile device may also host an email user agent that fetches new email messages from a remote mail server and places them in the source data store, and further, from time to time the email user agent or a related module hosted by the mobile device may check the size of the source data store, and, if the size exceeds a predetermined size limit, may compact the source data store by performing the step of subset selection and then saving the selected objects in a new target data store, deleting the source data store, and finally, using the new target data store as a new source data store for receiving new email messages.

Also in accord with the first aspect of the invention, the source data store may be hosted by a synchronization server and the target data store may be a data store on a synchronization client device, and the server may perform the step of subset selection of objects in the source data store so as to provide a set of objects not exceeding a size limit associated with the target data store, and may then transmit the objects to the client device. Further, the server may also transmit to the client device a marker and object fragment for all objects not selected for storing in the target data store, and if the client device deletes the marker, the server may transmit the full object in a subsequent synchronizing operation.

Also in accord with the first aspect of the invention, the steps of selecting and saving a subset may be performed from time to time by an email server using as the source data store a user mailbox, and using the target data store as a temporary data store, and from time to time the email server may check the size of the source data store, and, if the size exceeds a predetermined size limit, may compact the source data store by performing the step of subset selection and then saving the selected objects in a new target data store, deleting the source data store, and finally, using the new target data store as a new source data store for receiving new email messages.

In a second aspect of the invention, a computer program product is provided, comprising a computer readable storage structure embodying computer program code thereon for execution by a computer processor, wherein said computer program code comprises instructions for performing a method including: a step of selecting a subset of data objects from a set of data objects in a source data store; and a step of saving the selected data objects in a target data store; wherein the step of selecting the subset of data objects is performed according to a predetermined method for assigning utility for each of the data objects in the set of data objects.

In a third aspect of the invention, an apparatus is provided, comprising: means for selecting a subset of data objects from a set of data objects in a source data store; and means for saving the selected data objects in a target data store or for transmitting the selected data objects to another apparatus for saving the selected data objects in a target data store; wherein the means for selecting the subset of data objects does so according to a predetermined method for assigning utility for each of the data objects in the set of data objects.

In accord with the third aspect of the invention, and corresponding to the first aspect of the invention, the means for selecting the subset of data objects may include in the subset at least some data objects in the source data store having high utility according to the predetermined method for assigning utility, which may be based on a model that takes into account a plurality of factors, and provides weights for each of the factors, weights that may be based on monitoring access of the data objects by at least one user, or may be based on monitoring access of the data objects by a set of users, and then adapted to a particular user based on monitoring the particular user. Also, and again corresponding to the first aspect of the invention, the factors may be such that the utility assigned to a data object decreases continually over time, but is enhanced if the data object has not yet been viewed or if the data object is marked to indicate a follow-up action is required.

In a fourth aspect of the invention, a system is provided, comprising: a plurality of mobile devices; and an element of a telecommunications network coupled to the plurality of mobile devices and including or coupled to an apparatus for compacting data, the apparatus comprising: means for selecting a subset of data objects from a set of data objects in a source data store; and means for transmitting the selected data objects to one or another of the plurality of mobile devices for saving the selected data objects in a target data store on the one or another of the plurality of mobile devices; wherein the means for selecting the subset of data objects does so according to a predetermined method for assigning utility for each of the data objects in the set of data objects.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram of a module for selecting a subset of objects from a source data store, according to the invention.

FIG. 2 is a flow chart of a method provided by the invention.

### DETAILED DESCRIPTION OF THE INVENTION

Conceptually, the invention takes as input a set of data objects (e.g. each data object being data in a record or file, or the record or file itself) and a size quota Q for subsets of the set of data objects. It considers every possible subset of data objects of size no greater than Q, and selects the subset with the highest total utility to the user based on summing the utility of the individual data objects in the subset, where the assigned utility of a data object indicates the estimated probability that the user will access the data object next, before any of the other data objects in the set. Put another way, the invention minimizes the probability of a miss on the next access.

The invention relies on a probabilistic model to estimate the utility of a data object. A parametric form of the model is described below, as well as how to estimate values for the model parameters using maximum-likelihood by observing the behavior of a collection of users over time. In addition, we also describe how, after assigning a utility to each data object in the (full) set of data objects, the invention searches for the ideal-utility-maximizing and quota-respecting-subset of data objects.

Assigning Object Utility

Consider a set of data objects C from which the invention must select a subset. In general, some of these objects are newer, some older; some have recently been written/edited/accessed by the user, and others have not seen activity for a long time. Most importantly, there is one object, whose identity is unknown to the invention, that the user will access next, from among all the data objects in C. We can postulate a probability distribution over C with a probability assigned to each data object in C by a model, where the probability assigned is the likelihood that the object will be accessed next. Such a probability for a data object—the probability that the data object is the “next to be requested” object—is here called the “utility” of the data object.

To make the discussion more concrete, consider the case where the collection C is a mailbox. At any instant, a user has some number of messages—call it N—in the mailbox. There is one message that the user will view next, from among all the messages in the mailbox. We assign a probability distribution over the messages, where the probability assigned by the model to a message is the likelihood that the message will be viewed before any other messages currently in the mailbox.

The probability distribution—and even the form of the distribution—is unknown to us, but we can make some educated guesses about it. Some messages—e.g. messages with subject lines indicating other than business or personal communications, for instance including “cable descrambler” or “diet pills” in the subject line—have a vanishingly small probability of being read next, while others—e.g. a just-recently arrived message from the CEO—have a high probability. Generalizing, we can place a probability distribution over all N messages in a mailbox. Denote by X the random variable indicating which message from among the set {1, 2, 3 . . . N} in the mailbox will be read next by the user. Also, denote by x the value of this random variable, and by P(X=x) the probability of the event that message x will be read next by the user.

In general, a predictive model of user's message-access behavior will assign a value to P(X=x) by taking into account many variables, including for example one or more of the following: the age of the message x; the sender of x; the subject line of x; the existence of certain key words/phrases in the subject line of x; whether x has been marked for follow-up; whether x has been marked as ‘important’; the number of times that x has already been read; and whether there exists in the mailbox a newer message in the same thread.

Note that the size of x is not among the variables listed above. This is intentional; in this context we consider the size of a message to be itself a dynamic quantity, since the message is subject to compaction. That is, the size is not an independent variable.

A reasonable starting point for a model for providing P(X=x) is a mixture of models:

$$P ( X = x ) = A \frac{{ⅇ}^{- λ a ( x )}}{{Z}_{1}} + B \frac{U ( x )}{{Z}_{2}} + C \frac{F ( x )}{{Z}_{3}} \qquad ( 1 )$$

where 0≦A, B, C≦1 are weighting factors, obeying the constraint,
A+B+C=1,
where a(x)is the age of the data object x (in this case a message), measured in discrete units such as days, where U(x) is a predicate/logical function having a value of either zero or one and that evaluates to one if and only if message x is unread, where F(x) is a predicate that evaluates to one if and only if message x has been flagged for follow-up, and where, except for a caveat,

$${Z}_{1} = {\sum }_{x = 1}^{N} {ⅇ}^{- λ a ( x )} and {Z}_{2} = {\sum }_{x = 1}^{N} U ( x ) and {Z}_{3} = {\sum }_{x = 1}^{N} F ( x )$$

and are all normalizing factors. The caveat has to do with cases where either Z₂ or Z₃ are zero. Note that Z₂=0 when the mailbox contains no unread messages. This leads to an undefined value for the second term in eq. (1) because of a division by zero. In an implementation of the invention, we simply define the second term in eq. (1) to be zero if no messages are unread. A similar issue arises for and so we simply define the third term in eq. (1) to be zero if no messages are unflagged.

The form of P(X) given by eq. (1) provides that the utility of a message—in the sense used here—decays exponentially with time (first term), but is enhanced if the message has not yet been read (second term) or if the message is marked for follow-up (third term).

The age indicated by a(x) in eq. (1) has many different possible interpretations, including the amount of time since the message was sent or received, or the amount of time since the message was last read. It is the last of these interpretations that the invention typically employs. The intuition behind this choice is that a message received two weeks ago but last accessed an hour ago is more likely to be accessed again sooner than a message received one week ago that has not been looked at since.

The model corresponding to eq. (1) gives what is sometimes only a very coarse estimate, one which does not take into account many of the previously-mentioned factors bearing on the likelihood that a message will be the next one viewed. One can postulate a more intricate model, incorporating additional factors. The benefit of a mixture-model formulation is that it easily accommodates additional factors, each with their own coefficient. Another benefit of a mixture model is that ineffective models (those with poor predictive ability) do no harm; maximum-likelihood estimation, described below, is a recipe for discovering optimal weighting values for the constituent-models. Given a sufficient amount of data, maximum-likelihood will assign a small weight to ineffective factors.

In implementing the invention, whenever the invention performs a mailbox compaction, it must compute P(X=x) for every message x in the mailbox. A naïve implementation could be CPU-intensive. But the following few observations are helpful in providing an efficient implementation:

First, Z₂, the number of unread messages in the mailbox, multiplied by B, would be calculated in a naïve implementation by visiting all messages in the mailbox. Rather than doing so, however, mail clients can determine this information directly from many mail servers via an API call. For example, this number can be determined directly from an IMAP mail server by issuing a “STATUS” command to the mail server, per the format: STATUS [folder name] (UNSEEN).

A similar strategy applies in determining Z₃.

Computing Z₁ in the obvious way requires calculating e^{-λa(x)} for every message x. But assuming time is measured in (an integral number of) days, we can save on computation (of Z₁) by calculating the value of e^{-λt}, once and for all, for all values of t=0, 1, 2, 3, . . . days, and then recording the results in a table. Denote the recorded values by mₜ=e^{-λt}. Now, say we need to compute Z₁ and there are nₜ messages in the mailbox that are t days old. Then, we can write Z₁ as a dot-product (scalar multiplication of two n-tuples) of these two terms:
Z₁=A(n₁m₁+n₂m₂+n₃m₃+ . . . ).

In the above description, we have restricted attention to the case where C is a set (collection) of messages (e.g. in a mailbox). The model represented by eq. (1) is specific to this case. But it is simple to design a model for other objects, such as calendar entries or files. In the latter case, a model would take into account factors such as: the age of the file x; the mime (multipurpose Internet mail extensions) type of x; and the number of times that x has already been accessed. The invention is not limited to any one particular formulation for P(X). The invention in an embodiment using eq. (1) is merely indicative of one or more of many different possible embodiments.

Finding an Optimal Subset

The above description shows how the invention assigns a utility score to each object in a set (collection) of objects. We now describe how to use such a score (measure of utility) to decide which objects should comprise a selected subset—the subset restricted in size by some criterion, and having the greatest possible utility of all possible similarly restricted subsets.

Formally, the subset-selection problem can be stated as follows.

Input: ‘tuples (sₖ, pₖ) where sₖ is the size of object k and pₖ, otherwise written as P(X=k), is the estimated probability that object k will be accessed next.

quota Q (limiting any possible subset so as to have a size not exceeding Q).

Output:

Subset S of the full set {1, 2, 3, . . . N} of objects, where the subset S satisfies two conditions:
1. Σ_{i⊂S}|xᵢ|≦Q, i.e. the total size of (number of bytes in) the selected subset does not exceed the quota.
2. Σ_{i⊂S}Pᵢ is maximal among all subsets that satisfy the first condition; i.e. the sum probability that the next object accessed by the user will be from S is maximized.

An exact solution requires searching over a space of solutions whose size is exponential in the number of objects in the collection, and so the invention settles for an approximation to the exact solution.

Parameter Estimation

In this section we describe two techniques, based on maximum likelihood, for calculating the A, B, C coefficients of eq. (1). First we describe a static estimation technique for computing a single {A, B, C} triplet. Then we describe how the invention can adapt over time, by observing a user's behavior. That is, by keeping track of which messages a user views (and how quickly after a message's arrival it is read), the invention can adjust its model P(X=x) to be more consistent with the user's priorities, and so assign utility scores more in line with how the user would assign importance to a message. The technique is described here with reference to eq. (1), but the techniques apply equally well to an arbitrary number of models combined into a mixture model.

Maximum-Likelihood Estimation

Recall that the invention assigns a probability P(X=x) to each message x based on eq. (1), which includes three individual probability distributions or submodels, with coefficients A, B, and C, respectively, weighting the different submodels. The submodels use different information (age of the object, etc.) to assign a probability value to the object x and so indicate the probability that x is the object that will be accessed next from among all the objects in the full set or collection of objects. In interpreting the A, B, C coefficients as weighting factors, the relative size of A, for instance, corresponds to the weighting of the age-decay term in P(X).

The invention uses so-called maximum likelihood (ML) to provide values for the coefficients A, B, C of eq. (1). Taking the mailbox-compaction problem and using the model corresponding to eq. (1) as illustrative, to provide values for maximum-likelihood coefficient values—in what might be described as a learning process—we “watch” the user (by monitoring user interfacing activity) over a period of time as the user selects messages from the mailbox to read. Each time the user selects a message x, we record the triplet {e^{-λa(x)}/Z₁, U(x)/Z₂, F(x)/Z₃}, each component of the triplet indicating the score that the respective submodel would assign to the probability that x would be the next message accessed from the mailbox.

By observing a user's behavior over time, we can collect many such observations—called here single-user observations—and tailor the model to the user. We then observe a group of users and aggregate the observations together, thus tailoring the model to the group of users.

Using the aggregated single-user observations data, we count up each submodel's “score” (the sum of probabilities assigned to the subsequently-accessed object by the submodel) and normalize them, so that, e.g.:

$$A = \frac{{\sum }_{i}^{} \frac{{ⅇ}^{- λ a ( {x}_{i} )}}{{Z}_{1}}}{{\sum }_{i}^{} \frac{{ⅇ}^{- λa ( {x}_{i} )}}{{Z}_{1}} + \frac{U ( x )}{{Z}_{2}} + \frac{F ( x )}{{Z}_{3}}} ,$$

(with a similar calculation for B and C).

The calculation here results in static values for the coefficients A, B, C, i.e. one set of coefficients for all users. After determining such static values, the invention can be used to calculate utilities with eq. (1).

The problem with the approach above-described static calculation of A, B, C is that there simply is no one single setting for A, B, C that is optimal for all users. For example, some users will only view recently-arrived messages; for these users, A≈1 and B, C≈0. Some other users will view only messages marked for follow-up; for these users, C≈1 and A, B≈0. The fact that usage patterns differ among users argues in favor of an adaptive approach, one that takes into account the individual user when assigning utility scores. (Note that this is different from learning A, B, C values separately for each user, which would require that there be sufficient data for each user, when often the data are insufficient, and so the problem of learning A, B, C values separately for each user is often able to be characterized as a sparse-data problem: we may not have enough examples from each user to robustly estimate the parameters for each. In other words, there is value in pooling the training data together and estimating global A, B, C values, and then, for the users who provide us with enough additional examples, we can “learn” how their usage differs from the global norm, and update/adapt their individually A, B, C values accordingly. Such a procedure is often called Bayesian modeling.)

How the invention calculates utility scores may be customized to each user by observing the user's actions over time. In other words, the invention can account for individual user differences when predicting which object the user is likely to view next. To accomplish this, we first calculate a set of global coefficients in a static estimation phase as described above, as described above. Then the invention assigns each user a set of coefficient values. At first, the coefficient values for each user are set equal to the global coefficients calculated during the static/global ML estimation phase. But over time, the invention observes the mismatch between the estimated utilities and the actual message selected by the user, and adjusts the user's coefficient scores accordingly.

There exist learning algorithms used in language modeling and portfolio selection applications that prescribe a strategy for adapting the coefficients A, B, C adaptively, as new data is received. One such example is Cover's MIXER algorithm (Thomas Cover, “Universal portfolios,” in Mathematical Finance 1(1): Jan. 29, 1991). Cover's MIXER algorithm, which adapts the coefficient values dynamically as new data are received, is guaranteed to perform nearly as well as the best static mixture of models chosen in hindsight, after all data have been received. A more efficient algorithm—SWITCHER—which performs almost as well as MIXER, is described (in the context of language modeling) in “Online algorithms for combining language models,” by A. Kalai et al., included in Proceedings of the International Conference on Acoustics, Speech, and Signal Processing (ICASSP 1999).

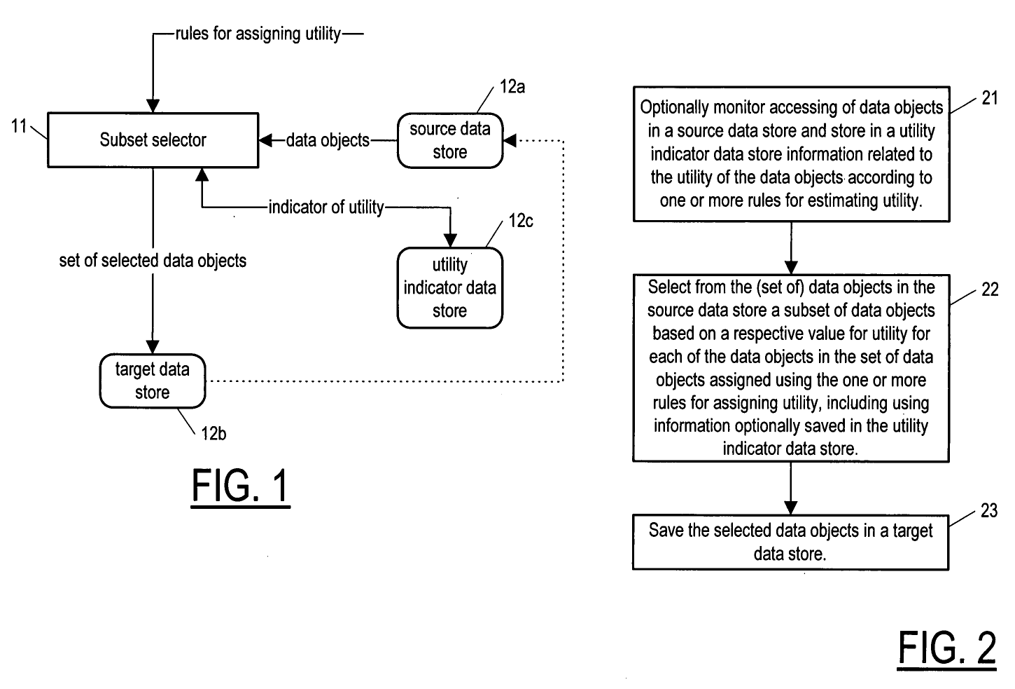

Thus, and now referring to FIG. 1, according to the invention a subset selector 11—which could be, for example, a module of a mobile messaging user agent of a mobile phone (not shown) as described below—saves in a target data store 12b a set of data objects selected from a source data store 12a based on assigning a respective value for utility for each of the objects in the source data store using one or more rules for assigning utility, rules which can be hardwired into the subset selector or which can be provided as input to the subset selector (and so changed from time to time). The assignment therefore can use, as described above, a mixture of rules for assigning utility. As described above, the subset selector typically selects as the subset that which, of all possible subsets, conforms to a predetermined quota—for example, it is no larger in size than some upper limit—and has the greatest total utility from among all such quota-conforming subsets. In assigning respective utility for a data object, the subset selector may use an indicator of utility in an optional utility indicator data store 12c, an indicator of utility (such as the number of times a data object is accessed in some time period) acquired over time by observing access by a user (or users) to the data objets in the source data store. To obtain such an indicator, a module (not shown) providing access to the source data store may inform the subset selector each time access occurs, or may provide information related to the indicator directly to the utility indicator data store. Alternatively, all access may be through the subset selector. The target data store 12b may then, in some embodiments (as describe below), be used as (or in place of) the source data store 12a so that the net effect is to compact the source data store (as indicated by the dotted line in FIG. 1).

Referring now also to FIG. 2, the invention is shown as providing a method including a first (optional) step 21 in which the subset selector 11 monitors accessing of data objects in the source data store 12a (directly or via a module providing such access) and storing in the utility indicator data store 12c information related to the utility of the data objects according to one or more rules for assigning utility. In a next step 22, the subset selector 11 selects from data objects in the source data store a subset of data objects based on a respective value for utility for each of the data objects in the set of data objects assigned using the one or more rules for assigning utility, including using information optionally saved in the utility indicator data store. The selected subset typically has a size less than some size limit (quota), and has the highest total assigned utility of all possible subsets having a size less than the size limit. In a next step 23, the subset selector 11 saves the selected data objects in the target data store or, if the target data store is hosted by an apparatus other than the apparatus hosting the subset selector, transmits them to the apparatus for storing in the target data store.

Some Illustrative Implementations

Mobile Messaging User Agent (MMA) of a Mobile Phone

Many MMAs of mobile phones may be configured to continually fetch new email messages from a remote mail server as they arrive, and then store them. Newer phones are able to communicate on high-bandwidth networks like 802.11x and 3G, which allows them to download large email messages quickly. Using high bandwidth networks, it does not take long for the storage capacity on a phone to become exhausted. Moreover, as mentioned earlier, even for large-capacity devices, many users tend to prefer to limit the number of messages stored on their MMA, to allow easy search and scrolling through the messages.

The subset-selection system of the invention can be installed as a separate application on a mobile phone or other mobile device. The invention can be implemented to run independently of the MMA but to have access to the MMA message store. The invention can be either configured by the user with a quota Q, or it may default to some fixed percentage of the available persistent storage on the device.

At a regular interval (or after each new message arrives in the MMA, if this information is available) the invention can be implemented to check the size of the MMA message store, and, if the size exceeds Q, to compact the mailbox by computing the utility of all objects and then performing subset-selection.

Since the mailbox-compaction process can be resource-intensive, it may be scheduled to be performed during hours of limited activity—when e.g. the phone/mobile device is being recharged, for example, or late at night.

In some applications it may be advantageous for the invention to be configured to respect the ‘important’ flag on a message. Such messages would then always be included in the selected subset S.

In addition, the invention may be implemented to retain email headers and delete only the body of messages in the subset of messages not selected. That way the user can see which messages have been removed from the MMA message store and can, if desired, use the MMA to download a message again from the mail server. (Of course, the user ought to then mark the message as ‘important’ to prevent it from being removed again).

The invention can of course also be configured to prompt the user interactively before removing messages.

Synchronization Server

The invention can be embedded in a synchronization server. One problem with synchronization is that a mobile device may not have sufficient storage capacity to retain all the data from such a server. Even if storage capacity is sufficient, the time and expense incurred by a full sync operation may be prohibitive. This is particularly true for the very first client-server synchronization operation. And it is especially true when the synchronization is performed over low-throughput radio or IR (infrared) channels, e.g. CDMA, GPRS or Bluetooth channels.

To address these problems, a synchronization server often assigns a special category or directory (folder) on the synch server where users should place objects (messages, contacts, files, etc.) they want synchronized. Of course, this requires that the user manually annotate or move selected objects into the special category or directory. The invention's automatic subset-selection procedure is an alternative to this manual approach. The invention, embedded in a synchronization server, can provide from among all the possible data that might be synchronized only a compact, high-utility subset of the data for transmission to the mobile device.

In the SyncML (synchronization markup language)—as set out in SyncML Protocol v1.1.1, October 2002—the element named <freemem> provides a way for a client to specify a quota to a server. The protocol specifies that this information should be exchanged during sync initialization. The sync server therefore receives the value Q from a SyncML device.

A typical configuration for an invention-enabled sync server is to execute the subset-selection process only during slow sync (e.g. first-time sync). Follow-up sync operations would not usually require use of the invention since the amount of information to be synchronized would ordinarily be much less.

In a typical embodiment, an invention-enabled sync server calculates the maximum-utility Q subset of objects and transmits those to the client. It also sends a marker for all other objects—a message header for an email, for instance. In a refresh sync, all new objects created on the server since the last sync are transmitted to the client. If the user wishes to view a missing object, the user need only delete the marker, and the sync server will (on the next refresh sync operation) detect a change to the client object and transmit the full version of the object to the client.

The invention can be deployed in either the client (e.g. a PC) or the server (e.g. a groupware server).

The invention enables what might be called quick sync since only high utility objects are synchronized: the user can specify a time limit and the invention will synchronize the highest-utility subset of objects on the server within that amount of time. For example, a time limit of two minutes equates to about 500 KB over a 30 kb/s channel. The non-qualifying objects can be ignored altogether, or transmitted in an abbreviated form: header-only for email messages, for example. In the latter case, the client (e.g. a mobile device) may offer a user the ability to perform an on-demand sync of the full object from the server.

Mail Server

With the prevalence of attachments—e.g. images, word processing or spreadsheet or other so-called office documents, and audio/video files—email mailboxes can quickly become large. For example, a user receiving 10 MB of email every week requires less than two years to reach 1 GB in mailbox size.

Most corporations and ISPs place a limit on the amount of server disk space allocated to each user's mailbox. To comply with this limit, users typically either aggressively delete messages from the server, or download messages from the server onto the local message store on their PC/laptop. Neither solution is desirable: deleting a message in its entirety runs the risk that the message might be needed in the future, and downloading messages to a specific MUA (message user agent) doesn't allow for the possibility that a user might wish to access his mailbox from another MUA in the future.

The invention provides another solution: apply the invention-style compaction directly to the message store on a mail server. Actively compacting a mailbox that receives 10 MB/week into a mailbox that retains an average of 1 MB/week means it would take nearly 20 years for the mailbox to reach 1 GB. While compacting a message on the server, the original may optionally be retained in an archive file, e.g. a tape backup.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
a step of selecting a subset of data objects from a set of data objects in a source data store; and
a step of saving the selected data objects in a target data store;
wherein the step of selecting the subset of data objects is performed according to a predetermined method for assigning utility for each of the data objects in the set of data objects.

2. A method as in claim 1, wherein the step of selecting the subset of data objects is performed so as to include in the subset at least some data objects in the source data store having high utility according to the predetermined method for assigning utility.

3. A method as in claim 1, wherein the predetermined method for assigning utility is based on a model that takes into account a plurality of factors, and provides weights for each of the factors.

4. A method as in claim 3, wherein the weights are based on monitoring access of the data objects by at least one user.

5. A method as in claim 3, wherein the weights are based on monitoring access of the data objects by a set of users, and then adapted to a particular user based on monitoring the particular user.

6. A method as in claim 1, wherein the factors are such that the utility assigned to a data object decreases continually over time, but is enhanced if the data object has not yet been viewed or if the data object is marked to indicate a follow-up action is required.

7. A method as in claim 1, wherein the source data store is hosted by a mobile device and the target data store is a temporary data store existing only during a compacting of the source data store, and the mobile device also hosts an email user agent that fetches new email messages from a remote mail server and places them in the source data store, and wherein from time to time the email user agent or a related module hosted by the mobile device checks the size of the source data store, and, if the size exceeds a predetermined size limit, compacts the source data store by performing the step of subset selection and then saving the selected objects in a new target data store, deleting the source data store, and then using the new target data store as a new source data store for receiving new email messages.

8. A method as in claim 1, wherein the source data store is hosted by a synchronization server and the target data store is a data store on a synchronization client device, and wherein the server performs the step of subset selection of objects in the source data store so as to provide a set of objects not exceeding a size limit associated with the target data store, and transmits the objects to the client device.

9. A method as in claim 8, wherein the server also transmits to the client device a marker and object fragment for all objects not selected for storing in the target data store, and if the client device deletes the marker, the server transmits the full object in a subsequent synchronizing operation.

10. A method as in claim 1, wherein the steps of selecting and saving a subset are performed from time to time by an email server using as the source data store a user mailbox, and using the target data store as a temporary data store, and wherein from time to time the email server checks the size of the source data store, and, if the size exceeds a predetermined size limit, compacts the source data store by performing the step of subset selection and then saving the selected objects in a new target data store, deleting the source data store, and then using the new target data store as a new source data store for receiving new email messages.

11. A computer program product comprising a computer readable storage structure embodying computer program code thereon for execution by a computer processor, wherein said computer program code comprises instructions for performing a method including:
a step of selecting a subset of data objects from a set of data objects in a source data store; and
a step of saving the selected data objects in a target data store;
wherein the step of selecting the subset of data objects is performed according to a predetermined method for assigning utility for each of the data objects in the set of data objects.

12. An apparatus, comprising:
means for selecting a subset of data objects from a set of data objects in a source data store; and
means for saving the selected data objects in a target data store or for transmitting the selected data objects to another apparatus for saving the selected data objects in a target data store;
wherein the means for selecting the subset of data objects does so according to a predetermined method for assigning utility for each of the data objects in the set of data objects.

13. An apparatus as in claim 12, wherein the means for selecting the subset of data objects includes in the subset at least some data objects in the source data store having high utility according to the predetermined method for assigning utility.

14. An apparatus as in claim 12, wherein the predetermined method for assigning utility is based on a model that takes into account a plurality of factors, and provides weights for each of the factors.

15. An apparatus as in claim 14, wherein the weights are based on monitoring access of the data objects by at least one user.

16. An apparatus as in claim 14, wherein the weights are based on monitoring access of the data objects by a set of users, and then adapted to a particular user based on monitoring the particular user.

17. An apparatus as in claim 12, wherein the factors are such that the utility assigned to a data object decreases continually over time, but is enhanced if the data object has not yet been viewed or if the data object is marked to indicate a follow-up action is required.

18. A system, comprising:
a plurality of mobile devices; and
an element of a telecommunications network coupled to the plurality of mobile devices and including or coupled to an apparatus for compacting data, the apparatus comprising:
means for selecting a subset of data objects from a set of data objects in a source data store; and
means for transmitting the selected data objects to one or another of the plurality of mobile devices for saving the selected data objects in a target data store on the one or another of the plurality of mobile devices;
wherein the means for selecting the subset of data objects does so according to a predetermined method for assigning utility for each of the data objects in the set of data objects.
